(19) United States
(12) Patent Application Publication
(10) Pub. No.: US 2018/0307811 A1
(43) Pub. Date: Oct. 25, 2018

(54) PREVENTION OF SOFTWARE PIRACY EXPLOITING END USERS

(71) Applicant: Ice Frog Technologies, LLC, Milwaukee, WI (US)

(72) Inventor: Anthony Boldin, Brookfield, WI (US)

(73) Assignee: Ice Frog Technologies, LLC, Milwaukee, WI (US)

(21) Appl. No.: 15/956,473

(22) Filed: Apr. 18, 2018

Related U.S. Application Data
(60) Provisional application No. 62/487,030, filed on Apr. 19, 2017.

(51) Int. Cl. G06F 21/12; H04L 29/06

(52) U.S. Cl. CPC G06F 21/121; H04L 63/062; H04L 2463/102; G06F 2221/2141; H04L 2463/103; H04L 63/107

(57) ABSTRACT

Methods and systems for preventing piracy. One method includes providing software having an intended end user, where the software is configured to be activated by the intended end user. The method includes providing a database of allowed keys and storing a unique key associated with the intended end user within the database of allowed keys. The method includes requesting a key to be entered by a user to activate the software, matching the key entered by the user to the unique key, matching the unique key to the intended end user associated with the unique key, and presenting to the user the intended end user associated with the unique key. The method includes activating the software only when the key entered matches the unique key and the user matches the intended end user associated with the unique key.

### CROSS REFERENCE TO RELATED APPLICATIONS

This application claims the benefit of U.S. Provisional Patent Application No. 62/487,030, filed Apr. 19, 2017, which is incorporated herein by reference in its entirety.

### FIELD

The present disclosure generally relates to software piracy prevention, and more particularly to preventing the use of software by unintended end users.

### BACKGROUND

The Background and Summary are provided to introduce a foundation and selection of concepts that are further described below in the Detailed Description. The Background and Summary are not intended to identify key or essential features of the claimed subject matter, nor are they intended to be used as an aid in limiting the scope of the claimed subject matter.

Software piracy has historically meant copying or unauthorized copying. But now, the definition has been expanded to any copying or distribution of computer software in violation of its license agreement. This may be done through copying, downloading, sharing, selling, or any other use not permitted under the license. Although software publishers and retailers have invested substantial time and effort in preventing and detecting piracy, it is estimated that tens of billions of dollars in revenue are lost annually due to ongoing piracy.

### BRIEF DESCRIPTION OF THE DRAWINGS

The drawings illustrate the best mode presently contemplated of carrying out the disclosure. The same numbers are used throughout the drawings to reference like features and like components. In the drawings:

FIG. 1 depicts one embodiment of a process flow in accordance with the present disclosure;

FIG. 2 depicts one embodiment of a system in accordance with the present disclosure;

FIGS. 3-4 depict typical processes for activation;

FIGS. 5-7 depict embodiments of process flows in accordance with the present disclosure; and

FIG. 8 depicts an embodiment of a process flow for identifying an unauthorized activation server.

### SUMMARY

One embodiment of the present disclosure generally relates to a method for preventing piracy that includes providing software having an intended end user, where the software has features. The method includes configuring the software to be activated by the intended end user and configuring the software such that at least one of the features is performable only when the software is activated. The method includes providing a database of allowed keys and storing a unique key associated with the intended end user within the database of allowed keys. The method includes requesting a key to be entered by a user to activate the software, matching the key entered by the user to the unique key stored in the database of allowed keys, and matching the unique key to the intended end user associated with the unique key stored in the database of allowed keys. The method includes presenting to the user the intended end user associated with the unique key stored in the database of allowed keys and activating the software only when the key entered matches the unique key stored in the database of allowed keys and the user matches the intended end user associated with the unique key stored in the database of allowed keys.

Another embodiment of the present disclosure relates to a system for preventing piracy. The system includes software having an intended end user, where the software has features. The software is configured to be activated by the intended end user and is configured such that at least one feature is performable only when the software is activated. The system includes a database of allowed keys. A unique key associated with the intended user is stored within the database of allowed keys and the software is configured to communicate with the database of allowed keys. The software is configured to request a key to be entered by a user to activate software. The software is configured to match the key entered to the unique key stored in the database of allowed keys and to match the unique key to the intended end user associated with the unique key stored in the database of allowed keys. The software is further configured to present to the user the intended end user associated with the unique key stored in the database of allowed keys. The software is activated only when the key entered by the user matches the unique key stored in the database of allowed keys and the user matches the intended end user associated with the unique key stored in the database of allowed keys.

### DETAILED DISCLOSURE

This written description uses examples to disclose embodiments of the disclosed invention, including the best mode, and also to enable any person skilled in the art to practice or make and use the same. The patentable scope of the invention is defined by the potential claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The present disclosure relates to software piracy protection, and specifically to preventing or discouraging activation of software by users who are not the intended end users of a particular product activation key.

In recent years, software has principally transitioned from physical products, such as discs and CD-ROMs, to downloads and subscriptions from online retailers, publishers and manufacturers. With this transition, software developers and publishers have moved from distributing discs to distributing serial numbers and product activation keys as a means for activating the software for use. Under this modern distribution model, software piracy typically occurs by one of at least three mechanisms: mis-channeling, multiple activations, and cracking.

Mis-channeling occurs when a unique key within a set of allowed keys that is meant for one group of intended end users or one particular intended end user is activated and utilized someone else. In fact, the store selling the product or activating user of mis-channeled software is often unaware that piracy has even occurred. Under the previous regime, software piracy primarily entailed duplication, whereby CDs or DVDs and any corresponding packaging were duplicated and made to look as though they originated from the developer or manufacturer.

In contrast, software piracy today only requires the legitimate appearance of the download link and corresponding product activation key. For example, any wholesaler or retailer can purchase a product activation key intended for a group or a geographic region of use that has a favorable price from the software publisher, then sells the product activation key to a group or geographic region usually sold from the software publishers at a higher price. This is mischanneling is typically unknown through most of the supply chain.

While there are many examples of this buy-low, sell-high form of software piracy, the following examples are particularly prevalent. A product key is given or sold at a significant discount to an organization that is an educational customer, then sold to another party or business that is not an educational customer at full commercial price. A product key is given or sold at a discount to a computer builder, but once again mis-channeled and sold to a business or wholesaler at the full commercial price. A product key is given to a company or a person for free (perhaps as a special program), but again mis-channeled and sold to another company or person other than to whom the product key was intended. A product key is often offered at a lower price in regions of the world associated with lower income, such as China, India, and other developing nations, but again mis-channeled and sold in a higher-cost region of the world, such as the UK, the US, or other developed nations that command a higher MSRP. A product key could even be stolen and not paid for, and then gets into the marketplace at a low cost to the end user.

Other product classifications that are commonly mis-channeled to improper end users include consignment products, beta products, trial products, marketing products, promotional products, employee products, OEM products, and corporate licenses.

In each of these examples, the principle of mis-channeling is simple—the wholesaler or retailer buys low and sells high. However, this piracy practice is not simply a matter of supply and demand economics. The practice exploits good will discounting provided for a special group of intended users to wrongfully extract additional profits by selling these product activation keys to end users that are not intended to receive this discounting.

The present applicant has identified that in most cases, this mis-channeling occurs without the retailer's or end user's awareness. Generally, the software downloads the same, installs the same, and activates the same whether or not mis-channeling has occurred. In many cases, a user of mis-channeled software can even call or chat with the publisher's customer service line without any of the parties being aware of the problem. To the user, there is no difference in the process, provided that the entered key is within the database of allowable keys and, therefore, allows the software to properly activate. Therefore, the user blindly assumes that the product activation key received and entered was intended for them. The end user either does not, or cannot, notice that they have enabled the retailer to involve them in an act of piracy. In other words, the end user and retailer is unintentionally participating in piracy.

Another type of software piracy involves selling a unique key for multiple activations, and specifically for more activations than the license permits. In many cases, a software publisher permits a product activation key to be used for activation more than once, often with repeated activation subject to a set minimum timeframe between activations. This allows a legitimate purchaser of a product activation key to reinstall software after a computer has been reinstalled, or to accommodate other reasonable circumstances that require a typical user to legitimately reactivate during the useful life of the software.

Since the software anticipates multiple activations for this legitimate use under the license, no indication is provided to the end user that previous activations have occurred. Therefore, when the multiple activations violate the terms of the software license, is again unaware of the underlying piracy. To exploit this accommodation by software publishers, some wholesalers or retailers intentionally sell the same product activation key to multiple end users. This increases profits for the retailer by reducing the relative cost of each sale.

For example, a product activation key bought by a retailer for $200.00 has an effective relative cost of only $100.00 if the retailer then sells it twice. This allows the retailer to undercut the competition, double profits, or both, by simply delaying the second sale to accommodate the minimum timeframe between allowed activations. Once again, each individual end user is generally oblivious to this multiple activation occurring. Instead, each end user believes that they have purchased a legitimate product activation key intended for their activation as the intended end user, in accordance with the software publisher's expectations. In this case, too, the end user is unintentionally participating in piracy.

In other cases, the end user may be fully-aware of exploiting the ability to activate software multiple times. For example, one user may allow a friend to install a copy of the software, or may install the software on multiple machines in violation of the associated end user licensing agreement. In these cases, the additional step of visually notifying the user about intended end user information corresponding to the key the user entered, along with requiring the user to confirm that they are indeed the intended, may dissuade intentional piracy in some percentage of users.

Another form of piracy, which is generally an intentional act by the end user, is known as “cracking”. Cracking occurs when software is made to operate outside of its designed behavior. End users crack software for a number of reasons. Some do it because they cannot afford to buy a license, or simply do not want to buy a license. Others may not wish to buy a license based on a perceived temporary need for the software. Still others may be able to afford the license, but enjoy the intellectual challenge and the social element of the pride in successfully circumventing security measures and “gaming the system”.

There are multiple common methods for cracking software. A first exploits a trial period provided within the software to enable the software to run indefinitely. One common method for cracking software in this manner is to intercept the date checking from software to the operating system and back to the software again such that the software incorrectly determines that the trial period is still active. When the software calls the date from the operating system, it is intercepted by an intermediate code that returns a fake time/date back to the software. This method requires no change to the software itself. Instead, the faux time/date transmission is handled by an intermediate code outside of the software in question.

Another method for cracking software involves changing some of the code itself such that it will bypass checking functions, or even communicate to alternative activation servers. In one example, the code changes involve modifying one or more configuration files that the software uses to determine whether the software has already been activated. Specifically, the configuration file or files are modified such that the software appears to have been successfully and validly activated, when it in fact has not. These alternative configuration files are often referred to as “patches”. The development and deployment of such patches does not require modifying the core software, but simply the files that the core software communicates with.

Yet another method for cracking software is to change the code of the core software itself. This generally involves accessing the binary code of the software, often through the use of a hex editor or file comparator. By editing the hex or binary code itself, a pirate can manipulate the software to function differently than it was designed to function. In some cases, this involves bypassing communication between the software and the manufacturer's activation server or another server, bypassing a time check, or bypassing various other checks and communication pathways. Specifically, the pirated version of the code may be reprogrammed to check another file location or to communicate with a server other than the manufacturer's. Since this method generally requires manipulation of the core software code, the modified code has different hash values than the original code.

To date, software publishers have spent an enormous amount of time, money, and energy investing in physical mechanisms for detecting and thwarting software piracy. This also includes the extensive legal and other related costs for enforcing rights in software against pirates, much of which is against those who had no idea that they were violating the license agreement In view of the issues that the present inventor has identified and described above, the presently disclosed methods and systems have been developed for preventing software piracy in the modern age.

In certain embodiments, preventing and/or identifying software piracy targets the fact that most retailers and end users are not even aware that piracy has occurred, particularly in the cases of mis-channeling and multiple activation piracy as previously described. Specifically, the applicant has developed methods and systems for preventing the piracy of software by catering the principled good nature of typical end users purchasing the software.

Generally, an honest person does not want to pay for software knowing that it was not intended for them, but for someone in another country, for use in a school, or someone else that already activated it using the same product activation key in the past. Certain embodiments of the presently disclosed solutions involve interactions and feedback directly with the end user or consumer during the activation process, which the present inventor also refers to as Intelligent Interactive Activation, or Active Customer Engagement Anti-Piracy Protection. Unlike systems and methods for preventing piracy known in the art today, the presently disclosed systems and methods empower the end user to keep retailers honest, effectively halting the demand for this type of piracy.

In one embodiment, during the software activation process as otherwise generally known, a dialogue box is presented to the user that indicates the intended end users and/or circumstances of use covered by that unique key. If this information is not aligned with that particular user, the user is then empowered to identify the discrepancy and to demand a return, an exchange for a legitimate product activation key, or some other credit for not receiving what was advertised. Because there would no longer be a consumer demand for these pirated product activation keys, this form of piracy could be nearly eliminated all together.

In certain embodiments, the user is further prompted to provide information about where the software was purchased, avoiding costly investigation for identifying the pirating sources.

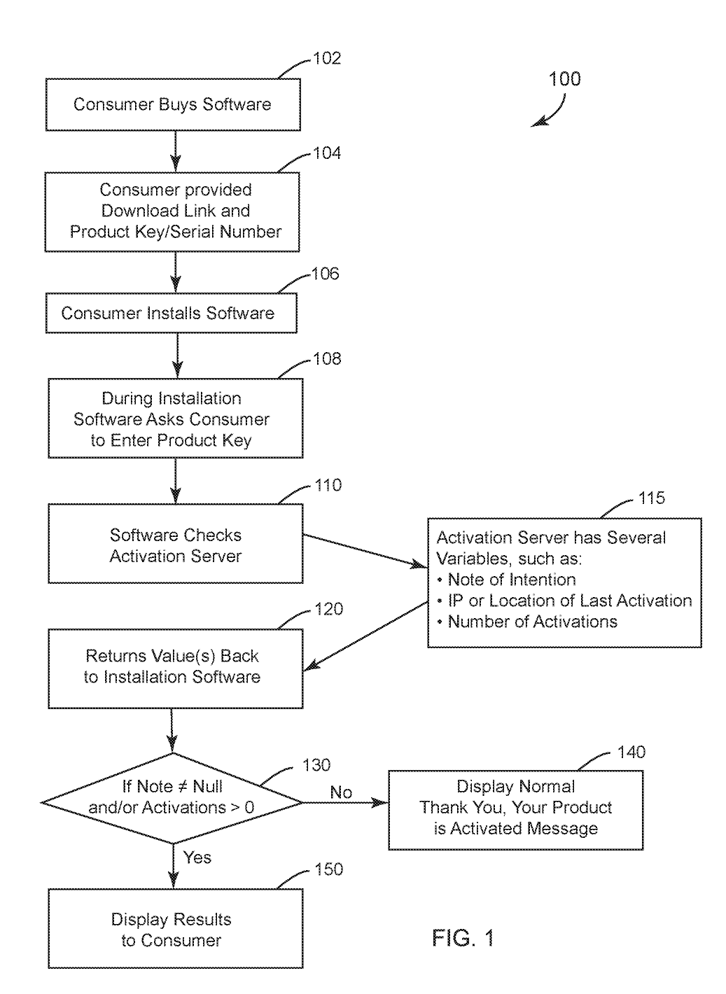

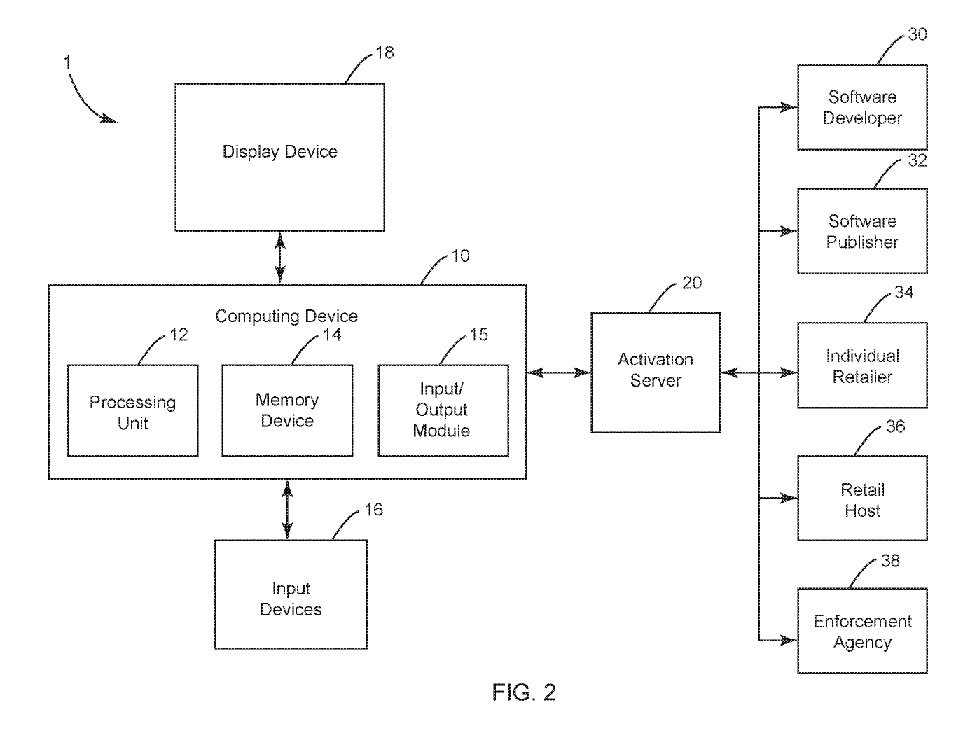

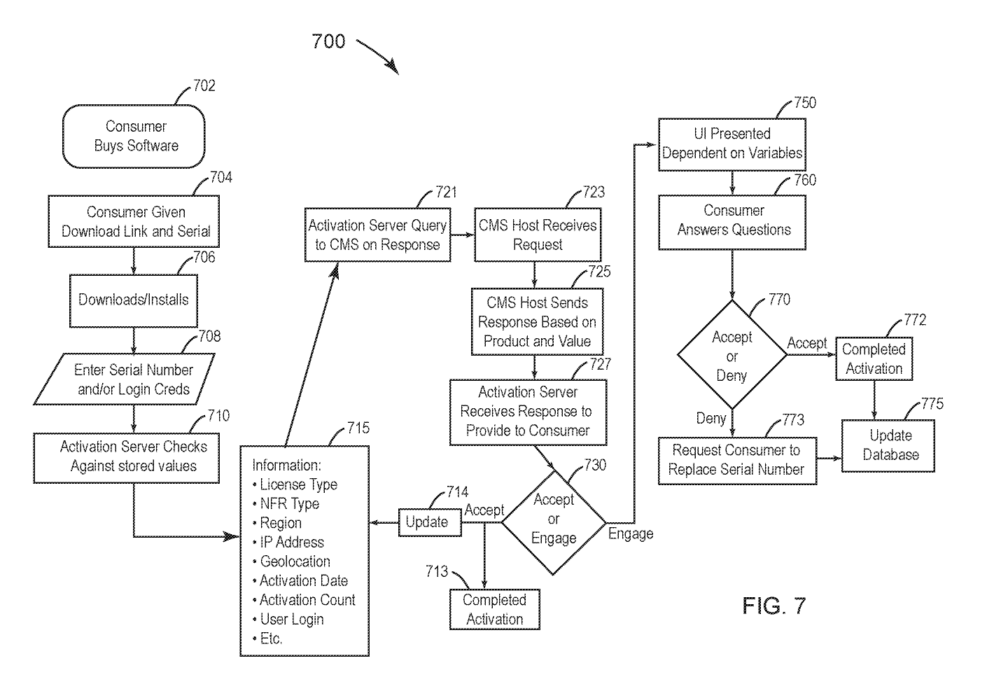

FIG. 1 discloses a high level process view of one embodiment of the present disclosure for preventing software piracy. FIG. 2 discloses one embodiment of a system configured to operate using the process flow disclosed in FIG. 1. FIG. 7 discloses an embodiment similar to process 100 of FIG. 1, preventing an end user from unintentionally or unknowingly participating in piracy. With reference to the software piracy prevention shown in process 100 and process 700 of FIGS. 1 and 7 (and system 1 of FIG. 2), the consumer purchases the software in step 102, for instance, through a retail host 36 such as online retailer Amazon.com. In step 104, the user is provided with a download link and a product activation key, sometimes referred to as a serial number, for activating the software on a computing device 10. A particular serial number may also be referred to as a unique key. Examples of a computing devices 10 include a personal computer connected to a display device 18 and a portable device.

The software is installed onto the computing device 10 in step 106. This entails communication with a processing unit 12 and memory device 14 as known in the art. During installation, step 108 includes the software requesting the user to enter the product activation key provided in step 104, for example through input devices 16 in communication with an input/output module 15 as known in the art. For example, the input devices 16 may include a keyboard, mouse, and/or touch screen. Other inputs, such as the time, date, and location of the computing device 10 may also be inputted. It should be recognized that the location may include at least a physical, geographic location and/or an IP address. Any and all input information may be stored as activation information for later reference, which is discussed further below.

In step 110, the software compares the product activation key to a database of allowed keys stored, for example on an activation server 20, to determine whether that product activation key is among those allowed. In the embodiment shown in FIGS. 1 and 2, this comparison is made by the processing unit 12 using a program stored in the memory 14, as known in the art. This process includes some activation steps known in the art today, including, that the product activation key exists within the activation database of allowed keys. However, as shown in step 115, the activation server 20 also contains other variables for comparison, as provided in the presently disclosed methods and systems. Examples of these other variables include a note of intention, which may include intended end user information, an IP address, and/or a location of a previous activation for that unique key. Further examples are also shown in FIG. 7 within step 715. These variables may also include the number of previous activations and associated activation information for that unique key's prior activation uses, as well as other information useful for preventing and/or detecting piracy.

It should be noted that in most cases, a given variable can be asked of the user for later comparison, shown to the user during or after the activation process, or any combination thereof. Likewise, information obtained from the end user or consequent to an activation attempt may be incorporated into these variables for later use (such as shown by step 714).

The intended end user information may include the intended user for that product activation key, such as a particular company or individual, a type of company such as a non-profit versus a corporation, and/or an educational or other specific-purpose use. This intended end user information is stored for comparison in step 115 may also include different regions of intended use, including specific countries or continents as previously discussed. The IP address or location of a last activation may also be stored in the activation server among the activation information of interest when the present user attempts to activate the software. This activation information may be of particular interest if the IP address or location of last activation indicates that a previous activation using the same product key likely originated with a different party. Likewise, the number of activations may be provided in the activation server 20 as further activation information of interest for the present user to determine whether the newly purchased product key is new, or has been sold and activated previously.

After the product activation key is checked against the activation server 20 in steps 110 and 115 including the information and variables from steps 115 and 715 previously discussed, values are returned to the installation software in step 120. In step 130, if the note of intention showing some of all of the intended end user information and/or activation information is empty and/or if the number of activations is zero, the software may display a normal “thank you” message to state that the product has just been activated, as shown in step 140. However, if the activation server contains notes of intention and/or other variables from step 115, and/or if the number of activations is greater than zero, such information may be provided to the user in step 150. For example, step 150 may display a message that the particular product activation key is intended for a specific school, and that if the user is not affiliated with that school, that the user is a victim of software piracy.

In addition to displaying such results to the user, the results may provide the user with options to report the software piracy or to buy a genuine key in place of the pirated one previously purchased. For example, the exemplary embodiment shown in FIG. 7 includes requesting the end user to replace the serial number in step 773 if it is determined that the end user is not the intended end user associated with the originally entered serial number. Some embodiments require the user to report where they bought it in order to complete the activation process, or will not allow activation until the user obtains a valid and proper key. In other embodiments, an activation button is made available to activate the software irrespective of whether the product activation key is included in the database of allowed keys with the user is aligned to the intended end user. In this case, activation is allowed despite the piracy, but nevertheless provides the user with the opportunity to report discrepancies to avoid future piracy. In other words, a software publisher 32, individual retailer 34, or retail host 36 may choose to allow the user to activate the pirated software in consideration for that user providing honest feedback, which can be used to prevent future piracy.

In another example, the display results provided in step 150 inform the user that the key has already been activated, that it was activated on a particular date, and in a particular location. For example, the display may show that “The software was activated on Jan. 1, 2017 in Chicago, Ill. USA. If this is not you, then you are a victim of software piracy. Please obtain a refund from where you bought it.” However, this message may be withheld from being displayed in step 150 if the IP address or geographic location of the present user is determined to be from the same vicinity as the first activation. Such a determination may indicate that the same user is merely reinstalling the software under normal use. Alternatively, the software may confirm this possibility by prompting the user to ask whether the present activation is a reinstallation. In this case, the previously described content may be shown during the prompt, or displayed only if the user replies that the present installation and activation is not a reinstallation.

The variables and information to store in the activation server 20 for comparison, along with corresponding display messages, are infinitely customizable. By way of example, the information to be provided to the user in step 150 may include:

This product key was for an educational facility.

This product key is intended for students only.

This product was activated previously X times. The last time was on XX/XX/XXXX in the state of XX. If this was not you, then this product key does not belong to you.

This product key is part of a free usage program.

This product key is for developers and testing only and not to be used in commercial or home use settings.

This product key was registered to Acme Company.

This product key is intended for use in China only.

Another embodiment of the present disclosure that includes additional exemplary intended user information and information that may be provided to the user is shown in FIG. 7. After the user buys the software in step 702, the embodiment of FIG. 7 provides that the user is given a download link and serial number or other credentials in step 704. The software is then downloaded and installed in step 706 and accepts the serial number and/or other credentials to be entered in step 708. The activation server checks the serial number and/or other credentials entered against allowable keys stored in the database. In some embodiments, the activation server communicates with a central management server (CMS) to request additional information associated with a key entered by the user, such as the exemplary information shown in step 715. Specifically, the activation server queries the CMS in step 721, the CMS host receives the request in step 723, and the CMS host sends information in response in step 725, based on the software, information entered, and information available. The activation server 727 then receives a response in 727 to provide to the user. In some circumstances, the serial number and/or other credentials are simply accepted in step 730 and activation is completed (step 713). In some cases, additional information is then added to the information stored in step 715, such as the geographical location in which an activation has occurred (step 714).

Alternatively, the user may be engaged in step 730 to respond to further questions presented on the user interface in step 750. Based on the user responses provided in step 760, the software will either accept or deny activation in step 770. If the responses from the user provided in step 760 are accepted, the activation is completed in step 772 and the database of information relating to that serial number is updated in step 775. If instead the responses from the user are denied, the embodiment of FIG. 7 requires the user to enter a new serial number in step 773. As shown, this denial is also updated in the database in step 775.

As previously stated, in addition to providing the note of intention and other variables and information from the activation server to the user in step 150, certain embodiments of the presently disclosed methods and systems further empower the user to take actions in response to this information. For example, the user may activate the software (perhaps even if the user is not the intended user, as previously discussed), may choose to not activate the software, to report the piracy to the software developer 30, software publisher 32, individual retailer 34, retail host 36, or enforcement agency 38 (see FIG. 2), and/or to purchase a genuine product key if the present product key is either not included in the database of allowed keys, or the user determines that they are not among the intended users for that product activation key.

Likewise, certain embodiments of the activation process are configured to automatically provide feedback to the retailer based on information about the present user and the variables associated with the intended end user. This feedback may further be bolstered by asking additional questions of the user, such in step 760 of FIG. 7. In certain embodiments, these questions include whether the present activation is a reinstallation or a first-time installation, where the user purchased the product activation key and when, and how much they paid for the product activation key, for example. In this regard, a retailer such as Amazon.com may automatically detect the mis-channeling of software by a particular vendor through feedback received by users upon an attempted activation. Amazon.com may then automatically issue a refund following such feedback, provide an alternate product activation key from the same or another vendor, or provide a complimentary product activation key in consideration for the user's honesty. Alternatively, the user may be requested to obtain a new serial number, such as shown in step 773, whether provided for free or through a new purchase.

It should be recognized that the system 1 shown in FIG. 2 depicts one embodiment for communication between the components shown. Other communication pathways and functional groupings are also anticipated by the present disclosure. For example, communication between and amongst components may be wired or wireless. Likewise, some components may be integrated together or separated apart from the exemplary system shown.

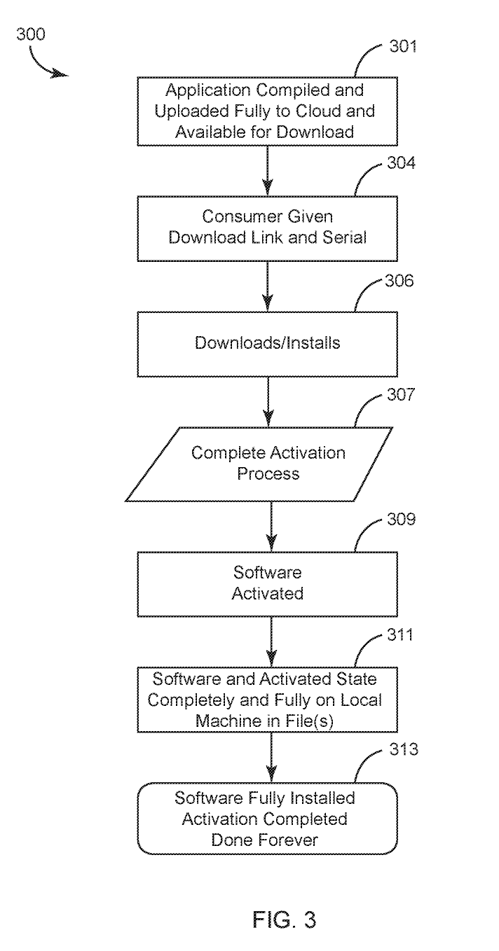

Other embodiments of the present disclosure particularly focus on preventing and/or identifying intentional piracy by users, including cracking and counterfeiting. FIG. 3 depicts a normal process 300 for installing and activating software. The process begins with the software being compiled and uploaded to a cloud in step 301, whereby it is available for download. A user then receives a download link and serial number or product key in step 304, and downloads and installs the software on their local machine in step 306. The user completes the activation process in step 307 using the serial number provided, which allows the software to become activated in step 309. In this normal process, the software is fully installed on the local machine, the activation file indicating the software's activated state is stored on the local machine (see step 311), and the activation is permanently completed (step 313). In other words, the entirety of the software code is installed on the local machine and activation is completed only once, leading to the cracking vulnerabilities discussed above.

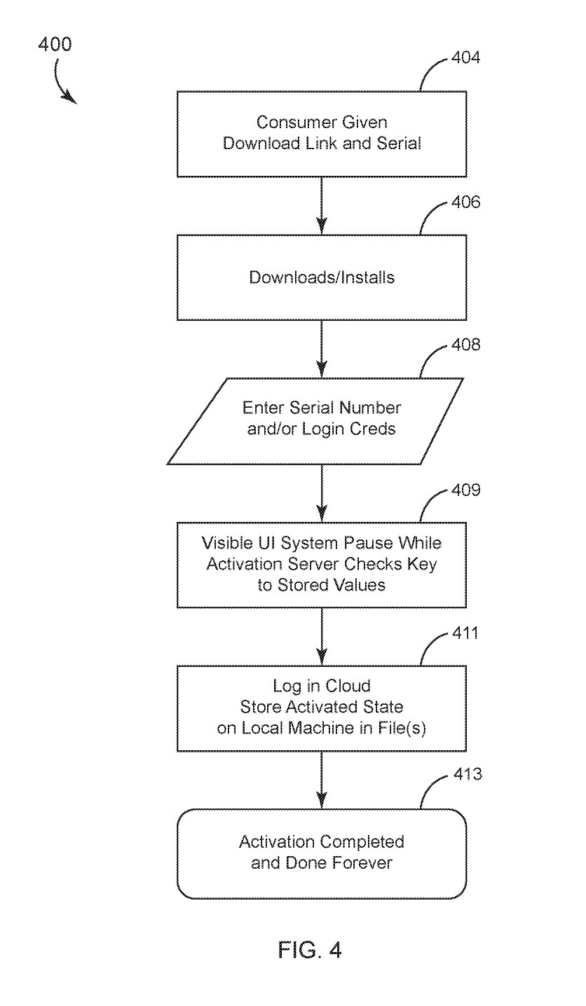

The process 400 shown in FIG. 4 is similar to that shown in FIG. 3, but depicts a configuration wherein the software is cloud-based (i.e., installed on a non-local machine). The user is given a download link and serial number (or other login credentials) in step 404, enabling them to download and in stall the software in step 406. The user then enters the serial number and/or other login credentials in step 408 and the visible user interface of the system pauses while the activation service compares the entered key information to allowable keys stored in the database in step 409. In this setup, although the software is stored in the cloud, the activation file is stored on the local machine in step 411. However, this activation process is once again considered permanent and is not repeated or later reconfirmed (see step 413). Therefore, as with process 300 in FIG. 3, the activation process 400 of FIG. 4 is completed only once and is vulnerable to cracking and other piracy efforts.

One solution to the intentional piracy presented herein is generally referred to as Application Splitting (AS) or Application Fissure. In presently disclosed embodiments incorporating AS, the software is divided such that some local portion is stored or installed on the local machine, and another remote portion is stored elsewhere. It should be recognized that in the present disclosure, storing and installing are used interchangeably. In this manner, a real-time connection to a server or other location storing the remote portion of software is required in order to execute any features (also referred to as remote features) corresponding to that remote portion of software. In certain embodiments, the remote portion includes one or more high-value features, such as opening or saving a file. In other cases, the remote portion includes software code necessary for starting up the application, for example. It should be recognized that a given feature may also be divided among the local portion and the remote portion to provide the piracy prevention presently disclosed.

As will be recognized, the remote portion of the code is thereby protected from cracking if it is stored in a location in the control of the publisher, for example. Thus, certain embodiments of AS also store the actuation file indicating the software activation status, software to confirm activation, or some combination thereof, within this protected space, thereby eliminating this vulnerability for piracy. Alternatively or additionally, the remote portion may be protected by other means, such as requiring a unique username and password.

It should be noted that, for clarity, the activation file is described as it being distinct from the software. However, the software code itself may include the activation file, for example, in the remote portion as described below.

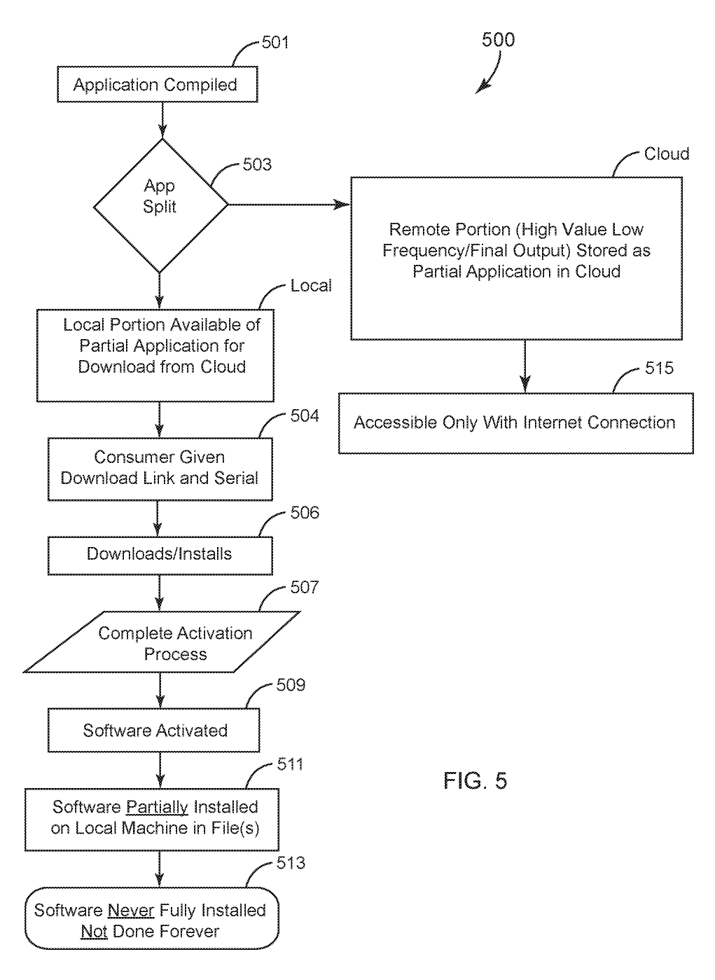

FIG. 5 depicts an exemplary embodiment incorporating AS to prevent piracy. As shown, the process 500 includes the compiled application (step 501) being split at step 503 to portions corresponding to remote portion and those corresponding to local portion. The remote portion is then stored in the cloud and the local portion is downloadable to be installed and stored on a local machine in step 506 using the download link and serial number (or other credentials) given to the user in step 504. The user enters the serial number and/or other login credentials and the application process is completed in step 507. Upon completion, the software is partially installed on the local machine in step 511, specifically the local portion. However, the remote portion is not installed locally. As such, unlike the process of FIG. 4, the software is never fully installed and, by virtue of retaining control of the remote portion, control of the software is not lost to the user forever (see step 513). In other words, the software developer or publisher retains control of the remote portion, which is accessible to the user only through a connection to the remote location in which the remote portion is stored (step 515).

It should be recognized that the local portion of the software corresponding to the local features need not be stored on a local machine, but in a location that is different from the remote portion, which may not be as protected from privacy. For example, local features could be installed on a user's cloud that is not secured by the publisher. The remote feature stored in the remote portion are then only available when the software is connected to the server or other storage site containing the code. As described above, certain embodiments require a username and password to access the cloud. This process of requiring and maintaining engagement with end users also allows the server or other storage site to revoke or modify activation status if a unique key is determined to be compromised.

Likewise, the remote features may be stored elsewhere than a site secured by the publisher, for example, a dedicated third party host that ensures the intensity of files stored thereon against piracy.

In further embodiments as described above, the remote portion of software stored on the server or other storage site also contains the activation file and/or activation-checking portion of the software itself. This protects and maintains the ability of the software to confirm activated state, since status and confirmation portions of code cannot be cracked to falsely indicate activation when the software has not been validly activated. Likewise, this configuration precludes cracking or otherwise modifying the software to direct activation confirmation to an unauthorized server (i.e., a pirate server), since only the legitimate server would contain the remote portion of the software corresponding to the desired, remote features.

Therefore it should be recognized that in certain embodiments, the remote feature may simply be maintaining an activation status and/or confirming this status. For example, an end user may be required to log onto the cloud for activation checking only. However in other embodiments, the remote portion includes, alternately or additionally, more substantive substitute features such as executing conversions, exporting, or enabling streaming, for example.

To maintain fast and responsive performance of the software, the remote features in some embodiments that are stored in the remote portion are features that are not used frequently, but which nonetheless have a high value to the end user (for example, saving or exporting files). Thus, while many functions are executed at the speed of the local machine, full use of the software requires use of the remote portion as well. In this manner, the software is never fully or permanently installed on the local machine, allowing the developer or publisher to retain control of at least the portion of the code remaining on its online server or in the cloud.

As previously mentioned, another solution to the intentional piracy presented herein is generally referred to as Asynchronous Continuous Activation (ACA). In certain embodiments, ACA does not allow the software to perform one or more functions (restricted functions) without confirming that the software has been activated. In certain embodiments, ACA requires confirmation of activation before high-value features can be executed, such as opening, saving, or exporting a file. In some embodiments, this confirmation is required every time a user attempts to perform a restricted feature. In other embodiments, confirmation is required periodically, depending on a delay or number of occurrences since the last confirmation for a restricted feature, for example.

In other ACA-incorporating embodiments, the requirement to confirm activation is tied to other triggers (alternatively, or in addition, to the execution of high-value features). By way of example, these include confirming activation when a user's IP or physical address changes or is different than expected, when other programs are detected to be running on the local machine, when a publisher so requests (such as in response to a newly identified vulnerability), or in other circumstances.

It should be recognized that Application Splitting and Asynchronous Continuous Activation may be incorporated independently, or together. However, it should also be noted that ACA does not require splitting into local and non-local portions of software.

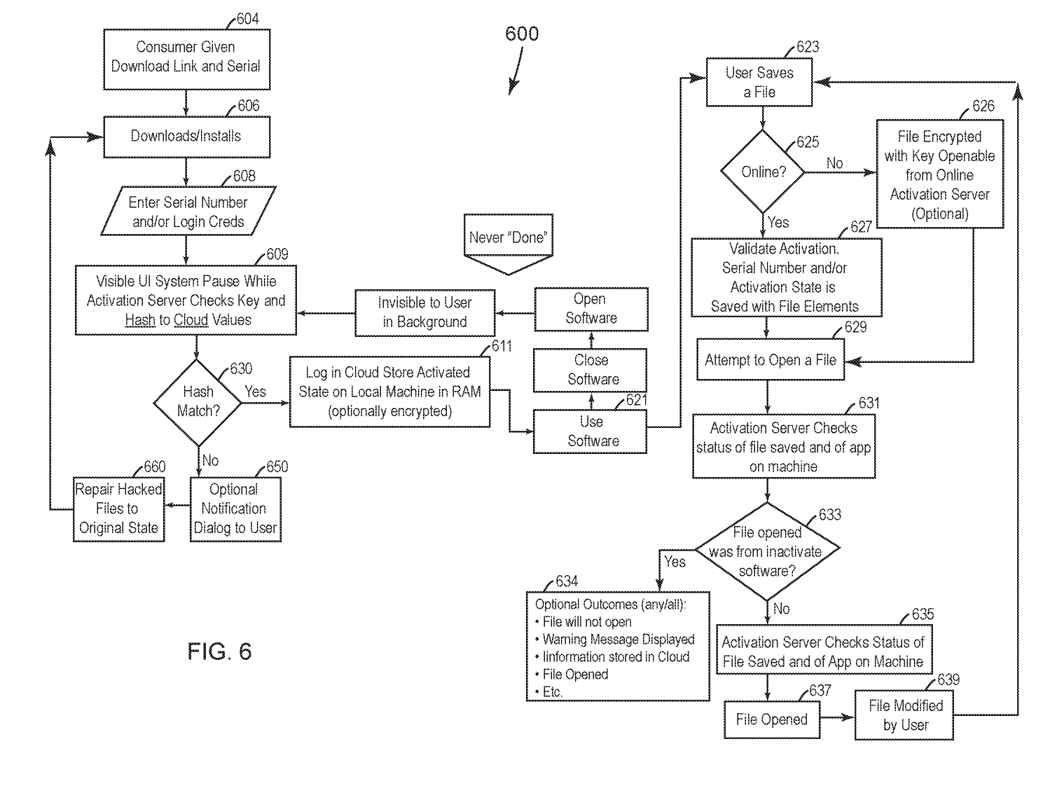

An exemplary embodiment incorporating both Asynchronous Continuous Activation and Application Splitting is depicted as process 600 in FIG. 6. While presently shown combined, Asynchronous Continuation Activation and Application Splitting may be employed alone, together, or in conjunction with other systems and methods for preventing and/or identifying software piracy, including the systems and methods for informing a user about the intended end user as described above (Intelligent Interactive Activation). As previously described, ACA provides that the software activation is not permanent, but must be periodically re-confirmed for the software to retain its full functionality. In the embodiment of FIG. 6, at least a portion of the software is cloud-based, but the activation file is stored on the local machine for later confirming activation. However, unlike processes and systems known in the art (which are vulnerable to local files being cracked), the embodiment of FIG. 6 allows the software to periodically perform file integrity checking of the activation files stored on the local device to detect any changes or replacements caused by cracking. This activation-checking portion of the code (used in step 631) is stored on the cloud to protect it from tampering, as previously described.

The embodiment shown in FIG. 6 further includes file integrity checking to ensure a valid activation on an ongoing basis by analyzing activation files and other files, directories, dates, and/or includes analyzing hash calculations and/or variable hash calculations with another factor of authentication. This checking may occur on a periodic basis using ACA triggers as discussed above, as a single occurrence upon installation, or at other times. In some embodiments, including those with at least a portion of the software being cloud-based, authentication factors are changed periodically, in some cases, daily. This additional factor of authentication is preferably stored at the manufacturer server level, as opposed to the local machine where it would be vulnerable to cracking. If the result of this file integrity checking analysis does not match expected values, deactivation may occur, and/or the Intelligent Interactive Activation process discussed above may be employed.

As shown in FIG. 6, the user is given a download link and serial number or other credentials in step 604, downloads and installs the software in step 606, and enters the serial number and/or other credentials in step 608. Steps 609 and 630 then compare a file hash value that is determined based on the code of the software and/or activation file to an expected hash value to detect pirated manipulation. If these hash values match, the software is permitted to connect to the cloud in step 611 to use the software as expected (see step 621). The user may also be notified in step 650, for example of the intended end user, as previously described. However, if the hash values do not match, the hacked files may be replaced or restored to original state in step 660. This configuration prevents bypassing future activation processes and/or leads to deactivation of one or more product features, effectively requiring the user to obtain a valid key.

It should be recognized that in addition to identifying activation files that have been cracked to incorrectly indicate an activated state, this process also identifies software that has been cracked to redirect activation confirmation efforts to pirate servers, rather than legitimate servers, to confirm a valid activation state.

In addition to performing hash value comparisons, the embodiment of FIG. 6 further divides the software using the AS processes along with the ACA process. Another example of AS and ACA processes is demonstrated by the software requiring confirm action of activation status when the user attempts to save a file in step 623. The software portion containing this saving process may be split apart from other portions of the software under the AS techniques described above, as opposed to the entire software being stored together. In embodiments storing the saving portion of software code on the cloud, the saving feature cannot be executed if the user is not connected to the internet (or has access to an activation server). In addition to this portion of the code remaining protected, requiring access to the cloud permits further requiring login authentication in certain embodiments. Thus additional layer of authentication only further challenges the ability for pirates to operate the software illegitimately.

In embodiments configured such that attempting to save a file triggers activation confirmation in step 627—thus requiring a real-time internet connection to function—the embodiment of FIG. 6 provides a further solution when such activation cannot be confirmed. Specifically, optional step 626 allows the user to save a file even when activation cannot be presently confirmed. For example, a user may be working outside of a Wi-fi or cellular range, or the internet connection may simply be down (see step 625). In this case, step 626 allows the file to be saved such that legitimate work is not lost, but encrypts the saved file with a key that is only available with access to the activation server. In this regard, while the user is allowed to save the file, that file can only be opened again (in step 629) by reestablishing a connection with the activation server. In other words, activation confirmation is required before that saved file can be decrypted to once again obtain access. As shown in step 631, when a user attempts to open such a file, the activation server checks the status of both the file, and of the software activation status. If the file opened is determined to not be from activated software in step 633, a number of different outcomes can arise, as exemplified by the content shown in step 634. In one example, the file simply will not open. However, other embodiments of the software provide other outcomes, such as warning the user in accordance with the Intelligent Interactive Activation techniques previously described.

If instead the file opened is determined to be from activated software in step 633 and both the file and the software activation status are confirmed to be properly activated in step 635, the file can be opened in step 637 and modified by the user (step 639).

It should also be recognized that while some embodiments were generally described as preventing unintentional piracy, and others with intentional piracy, the presently disclosed methods and systems may be combined and used together for further benefit. For example, an unsuspecting purchaser of pirated software may, upon receiving information of such piracy by the presently disclosed systems and methods, decide to continue using the software without reporting it. In this case, the additional implementation of Asynchronous Continuous Activation would nevertheless prevent the software from being operational, forcing the user to do the right thing by reporting the piracy. Similarly, an unsuspecting user may be told to install a patch that is in fact an unauthorized crack. By informing the user about the intended user for the given activation code, the otherwise-secret piracy can be detected and reported by that user.

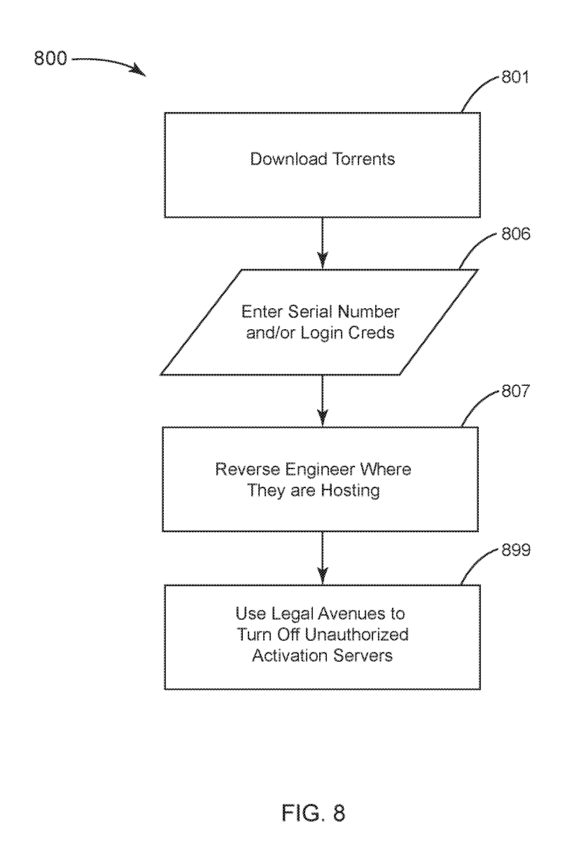

The present disclosure further depicts a method for resolving situations in which hacked software communicates with an unauthorized activation server. FIG. 8 depicts a method 800 for handling an unauthorized activation server used to allow pirated software to remain activated despite the software employing the techniques previously disclosed. Specifically, if at least a portion of activation occurs over the internet, such as through using a cloud server, hackers must have their own activation server to direct the software to. To identify such hacked activation servers, the software publisher obtains an illegal version of the software, such as through a download torrent (step 801). Upon entering the necessary serial number or login credentials in step 806, the owner can then analyze the code to identify which host server the cracked software is being directed to during the Asynchronous Continuous Activation process. Using this technique of reverse engineering (step 807), the owner can then use various legal avenues to identify and shut down these unauthorized activation servers (step 899). In this manner, shutting down the pirate server can simultaneously halt the operation of potentially hundreds or thousands of cracked installations.

In the above description, certain terms have been used for brevity, clarity, and understanding. No unnecessary limitations are to be inferred therefrom beyond the requirement of the prior art because such terms are used for descriptive purposes and are intended to be broadly construed. The different assemblies described herein may be used alone or in combination with other devices. It is to be expected that various equivalents, alternatives and modifications are possible within the scope of any appended claims.

I claim:

1. A method for preventing piracy, the method comprising:
providing software having an intended end user, wherein the software has features;
configuring the software to be activated by the intended end user;
configuring the software such that at least one of the features is performable only when the software is activated;
providing a database of allowed keys and storing a unique key associated with the intended end user within the database of allowed keys;
requesting a key to be entered by a user to activate the software;
matching the key entered by the user to the unique key stored in the database of allowed keys;
matching the unique key to the intended end user associated with the unique key stored in the database of allowed keys;
presenting to the user the intended end user associated with the unique key stored in the database of allowed keys; and
activating the software only when the key entered matches the unique key stored in the database of allowed keys and the user matches the intended end user associated with the unique key stored in the database of allowed keys.

2. The method of claim 1, wherein presenting the intended end user associated with the unique key includes visually displaying the intended end user associated with the unique key.

3. The method of claim 2, wherein the intended end user information includes that the intended end user is a student.

4. The method of claim 2, further comprising requesting the user to confirm that the user matches the intended end user.

5. The method of claim 4, further comprising offering the user to purchase of a new key for activation when the user indicates that the user and the intended end user are different.

6. The method of claim 4, further comprising requesting the user to provide seller information corresponding to the key when the user indicates that the user and the intended end user are different.

7. The method of claim 4, further comprising notifying a third party when the user indicates that the user and the intended end user are different.

8. The method of claim 4, wherein the unique key is removed from the database of allowed keys when the user indicates that the user and the intended end user are different.

9. The method of claim 7, wherein the third party is a software publisher of the software.

10. The method of claim 1, further comprising storing activation information each time the key is used for activation.

11. The method of claim 10, further comprising notifying the user of the activation information and requesting the user to confirm awareness of the activation information, wherein the activation information includes how many times the unique key has been used for activation.

12. The method of claim 10, wherein the activation information includes one or more previous locations of activation, further comprising comparing a user location of the user to the one or more previous locations of activation.

13. The method of claim 12, wherein the one or more previous locations and the user location are geographical locations.

14. A system for preventing piracy, the system comprising:
software having an intended end user, wherein the software has features, wherein the software is configured to be activated by the intended end user, and wherein the software is configured such that at least one feature is performable only when the software is activated; and
a database of allowed keys, wherein a unique key associated with the intended user is stored within the database of allowed keys, and wherein the software is configured to communicate with the database of allowed keys;
wherein the software is configured to request a key to be entered by a user to activate software, wherein the software is configured to match the key entered to the unique key stored in the database of allowed keys, and wherein the software is configured to match the unique key to the intended end user associated with the unique key stored in the database of allowed keys;
wherein the software is configured to present to the user the intended end user associated with the unique key stored in the database of allowed keys; and
wherein the software is activated only when the key entered by the user matches the unique key stored in the database of allowed keys and the user matches the intended end user associated with the unique key stored in the database of allowed keys.

15. The system of claim 14, wherein the software is further configured to present the intended end user associated with the unique key on a visual display, and wherein the software is configured to present to the user that the intended end user is licensed for non-profit use of the software.

16. The system of claim 14, wherein the software is configured to request the user to confirm that the user matches the intended end user.

17. The system of claim 16, wherein the software is further configured to notify a third party when the user indicates that the user and the intended end user are different.

18. The system of claim 14, wherein the database of allowed keys is further configured to store activation information about each time that the key has been used for activation.

19. The system of claim 18, wherein the software is further configured to notify the user of the activation information and to request the user to confirm awareness of the activation information, wherein the activation information includes a number of times that the key entered has been used for activation.

20. The system of claim 18, wherein the activation information includes one or more previous locations of activation, wherein the software is further configured to compare a user location of the user to the one or more previous locations of activation.
